(19) United States
(12) Patent Application Publication
(10) Pub. No.: US 2004/0184397 A1
(43) Pub. Date: Sep. 23, 2004

(54) Optical recording medium, method of producing the same and protective film-forming resin

(76) Inventors: Kazuta Saito, Tokyo (JP); Katsuya Takamori, Tokyo (JP)

Correspondence Address: 3M INNOVATIVE PROPERTIES COMPANY, PO BOX 33427, ST. PAUL, MN, 55133-3427, US

(21) Appl. No.: 10/484,281

(22) PCT Filed: Jul. 22, 2002
(86) PCT No.: PCT/US02/23070

(30) Foreign Application Priority Data
Jul. 27, 2001 (JP) 2001-228094

(51) Int. Cl. G11B 7/24

(52) U.S. Cl. 369/275.4

(57) ABSTRACT

An optical recording medium (10) comprising a substrate (1) and an information recording layer (2) formed thereon. The information recording layer (2) has a protective film (3) made of a light transmitting resin provided on its surface. The protective film (3) has a substantially even thickness in a range from 50 to 200 μm, and has a surface which reproduces the smoothness of the surface of a surface treatment medium which has been covering the surface of the protective layer (3) during the formation thereof.

### TECHNICAL FIELD OF THE INVENTION

The present invention relates to an optical recording medium and, more particularly, to an optical recording medium having a protective film provided on an information recording layer formed on a substrate. The optical recording medium is typically an optical disk. The present invention also relates to a method of producing an optical recording medium and a protective film-forming resin used in such a method.

### BACKGROUND OF THE INVENTION

As the multimedia technology advances, even the data of moving pictures and audio have come to be processed in the form of digital signals. Moving pictures and audio data generally contain a vast amount of information and therefore require a large capacity and high density medium to record them. As such a recording medium, optical disks such as DVD (digital versatile disk) and CD (compact disk) are considered to be promising for their capability to meet the future requirements for further larger capacity and higher recording density.

An optical disk typically comprises a substrate and an information recording layer and protective layer which are formed in order on the substrate, as will be easily understood from the detailed description of an optical disk of the present invention which will be given below with reference to the accompanying drawings. More specifically, a read-only optical disk, for example, comprises a disk-shaped substrate (made of polycarbonate resin, for instance) having pits which carry information on guide grooves formed on the surface thereof, deposited by an information recording layer made of aluminum or the like. The surface of the information recording layer is coated with a protective film made of a light transmitting resin in order to protect the optical disk from atmospheric moisture and mechanical damage. Reproduction of information from such an optical disk can be carried out by continuously irradiating the information pits on the guide grooves of the substrate with laser beam focused thereon by means of an object lens used for reproduction pickup.

Recent developments of the recording medium toward higher density and larger capacity make it necessary to further improve the protective film. For example, the protective film must have a high transparency to the reproducing light as the information is reproduced by means of irradiation with light. In addition, the protective film is required to be as thin as possible and have substantially uniform thickness over the entire surface of the recording medium with the surface being smooth. However, the conventional protective film does not fully satisfy these requirements.

The protective film of the optical disk is usually formed by, for example, applying an ultraviolet curing resin to the surface of the information recording layer to a predetermined thickness by the spin coating process, then curing the resin by irradiating with ultraviolet radiation. However, as shown in FIG. 1, the protective film 3 formed on the surface of the substrate 1 made of polycarbonate resin (the information recording layer is not shown for simplicity) tends to be thinner near the center of the disk and thicker near the periphery, with a ridge being formed along the periphery because the substrate 1 is rotated during spin coating. The ridge is typically 1 to 2 millimeter (mm) in width and 20 to 30 micrometer (μm) in height. Such a variation in the film thickness has an adverse effect on the reproduction characteristic and, in the case where a magnetic head is used as the reproducing means, may cause head crash or the like. Also a defect of radial configuration is likely to occur which is characteristic to the film forming technique by means of the spin coating process.

As the spin coating process is a very useful technique for forming a film, such a method for overcoming the problems described above has been proposed as disclosed in Japanese Unexamined Patent Publication (Kokai) No. 7-57297 where formation of the ridge is predicted in advance and, accordingly the substrate is tapered off near the periphery thereof. However, it is a tedious and costly operation to taper the substrate, and the tapered surface and the spin coating condition which are optimum for the particular case must be designed, and this method cannot be considered to be a solution which is generally applicable.

Other methods include lamination of a protective sheet, in which a disk-shaped sheet is punched out of a protective film sheet (made of polycarbonate, for instance) which is about 70 to 90 μm in thickness, and is laminated to the surface of the information recording layer of an optical disk via an adhesive agent or an adhesive sheet. However, this method has such drawbacks as the protective film sheet is expensive, the protective film sheet cannot be used efficiently because of punching off, and the sheet must be handled carefully so as to prevent bending of the sheet and other troubles. The adhesive agent used in this technique is typically an ultraviolet curing resin which has an intrinsic drawback of variation being caused in the thickness of the adhesive layer. In case an adhesive sheet is used, there arises a problem of disposing of a release liner, as well as the high cost of the sheet due to the special quality thereof.

An object of the present invention is to provide an optical recording medium having high quality which overcomes the problems of the prior art described above, has a protective film which is thin with no variation in the film thickness and has a smooth surface, thereby satisfies the requirements for larger capacity and higher density.

Another object of the present invention is to provide a method of producing the optical recording medium of high quality, which has a protective film which is thin with no variation in the film thickness and has a smooth surface, easily and at a low cost.

Still another object of the present invention is to provide a method of producing the optical recording medium which is free from such troubles as dust depositing on the protective film, scratches, bending, and defects in radial direction.

These objects and other objects of the present invention will be appreciated from the following detailed description of the present invention.

### SUMMARY OF THE INVENTION

The present invention provides, in one aspect, an optical recording medium comprising a substrate, an information recording layer formed on the substrate, and a protective film made of a light transmitting resin provided on the surface of the information recording layer. The protective film has a substantially uniform thickness in a range from 50 to 200 μm, and has a surface which reproduces the smoothness of the surface of a surface treatment medium which has been covering the surface of the protective film during the formation thereof.

The present invention provides, in another aspect, a method of producing an optical recording medium comprising a substrate, an information recording layer and a protective film which are formed in order on the substrate. The method which comprises the steps of:

(i) applying a light transmitting protective film-forming resin, to the surface of the information recording layer, in an amount sufficient to form the protective film having a thickness in a range from 50 to 200 μm;

(ii) covering the surface of the protective film-forming resin with a surface treatment medium which has a surface smoothness which corresponds to the smoothness required of the protective film;

(iii) forming the protective film by curing the protective film-forming resin under the condition such that the smoothness of the surface of the surface treatment medium is transferred onto the protective film; and

(iv) optionally removing the surface treatment medium.

Further, in still another aspect thereof, the present invention provides a protective film for an optical recording medium, comprising a protective film-forming photocurable resin. The photocurable resin is cured by light which has transmitted through an adjacent medium thereby to form the protective film.

In the optical recording medium of the present invention, since the space between the substrate and the surface treatment medium which are disposed in parallel to each other is filled with the protective film-forming resin which is then cured, the production process can be simplified. The thickness of the protective film can be easily decreased, while the thickness can be made substantially uniform. Also by using the surface treatment medium which has excellent flatness and smoothness, the flatness and smoothness of the surface treatment medium can be accurately transferred onto the surface of the protective film, and the radial defects encountered with the spin coating process of the prior art can be prevented from occurring. Moreover, since the protective film-forming resin is inexpensive and readily available commercially, the production cost can be kept far lower than that of the prior art.

### BRIEF DESCRIPTION OF THE DRAWINGS

FIG. 1 is a cross sectional view showing problems during the formation of a protective film in a method of producing an optical disk of the prior art.

FIG. 2 is a cross sectional view showing schematically one embodiment of the optical disk of the present invention and use thereof.

FIG. 3(A) to (D) are cross sectional views showing in sequence one preferred method of producing the optical disk according to the present invention.

FIG. 4(A) to (D) are cross sectional views showing in sequence another preferred method of producing the optical disk according to the present invention.

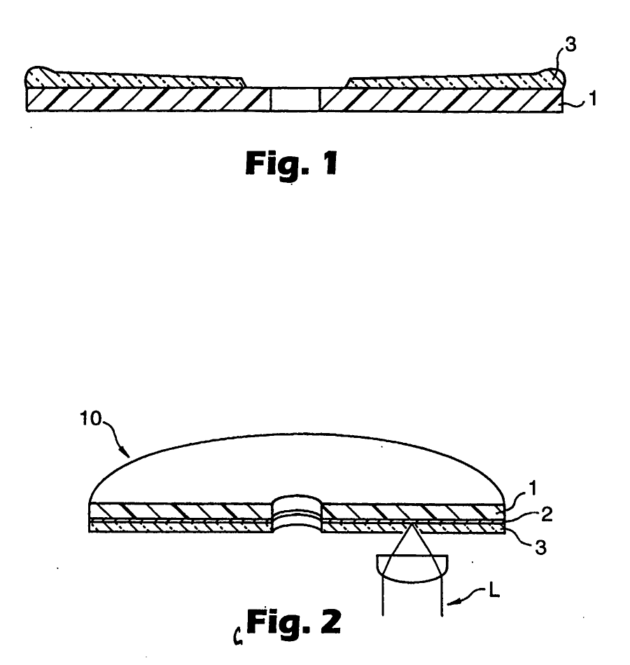

### DETAILED DESCRIPTION OF THE PREFERRED EMBODIMENT

While the optical recording medium of the present invention may have various constructions according to the method of recording and reproducing the information which is employed, it is basically constituted to include at least:

(1) a substrate;

(2) an information recording layer formed on the substrate; and

(3) a protective film which covers the surface of the information recording layer.

A typical example of such optical recording media is an optical disk such as CD and DVD. The protective film of the optical recording medium according to the present invention may also be used in any fields other than the optical recording medium as required, by making use of the good quality thereof.

FIG. 2 is a perspective view showing an embodiment of read-only optical disk (DVD) according to the present invention. The optical disk 10 comprises a substrate 1 made of a transparent resin (polycarbonate resin, for instance), with a pattern of pits (not shown) corresponding to given information being formed on the surface of the transparent substrate 1. The optical disk 10 has a circular hole (aperture) made at the center thereof. To set the optical disk 10 on an optical disk apparatus, the aperture of the optical disk is fitted with a shaft of the apparatus. Formed on the transparent substrate 1 is an information recording layer 2 which is made of a metal such as aluminum and has reflectivity of around 90%. Surface of the information recording layer 2 is coated with a protective film 3 made of a light transmitting resin in order to protect the information recording layer from the atmospheric moisture and mechanical damage. Reproduction of information from the optical disk 10 can be carried out by irradiating the optical disk with a laser beam L from an optical head (not shown) and receiving the light reflected from the information pits of the information recording layer 2.

While the optical disk used only for reproduction is shown in the drawing, the optical disk of the present invention is not limited to this embodiment. The optical disk of the present invention may also be an optical disk which allows both recording and reproduction of information, or an optical disk having the information recording layer and the protective film provided thereon on both sides of the substrate. Further, the optical disk of the present invention may be an optical disk which utilizes magneto-optical phenomenon or phase change for recording and reading information.

In the optical recording medium of the present invention, there is no limitation to the substrate which carries the information recording layer. The substrate may be transparent, semi-transparent or opaque depending on the method of recording and reading information which is employed. The substrate may be formed from a plastic material such as acrylic resin and polycarbonate resin by an ordinary molding method such as injection molding process, as is common in this technical field. Alternatively, a material other than the plastic material, i.e., glass and others, for example, may be used in some cases. The substrate may be made in various sizes depending on the size of the optical recording medium required. For example, in the case of the commercially available optical recording medium such as DVD, the substrate is 12 centimeters (cm) in diameter and 0.6 mm in thickness. The optical recording medium may also have a shape other than a disk shape, if necessary.

Among the surfaces of the substrate, the surface whereon the information recording layer is formed has a pattern of grooves or pits, which correspond to the signals which represent the image or sound to be recorded on the optical recording medium, formed thereon. The pattern of pits may be formed by master stamping or photolithogaphy. The pattern of pits may not necessarily be formed on the substrate surface depending on the method of recording and reading information.

As in the case of the substrate, there is no limitation to the information recording layer to be formed on the substrate. The information recording layer is usually formed in a thin film from a metallic or ceramic material suitable for forming a reflective or semi-transparent recording layer. Materials suitable for forming the information recording layer of reflecting type include those having a reflectivity of around 90% after the film has been formed, for example, aluminum. Materials suitable for forming the semi-transparent recording layer include those having a reflectivity of around 50% after the film has been formed, for example, gold, silicon-based dielectric material (including silicon nitrides generally represented by SiNx or SiC, etc.). These materials may be formed into the recording layer by the ordinary thin film forming techniques such as sputtering and vacuum vapor deposition processes. Thickness of the information recording layer may be selected from a wide range, but is typically in a range from about 10 to 500 nanometers (nm).

The protective film provided on the top of the optical recording medium is formed from a light-curable resin, i.e. the resinous material curable upon light irradiation. Note that the term “light” used herein is intended to mean different types of light including radiations such as visible light and UV light, and electron beam and others. Thus, the light-curable resin materials suited for forming the protective film include, for example, ultraviolet (UV)-curing resin and electron beam (EB)-curing resin. Appropriate light-curable resins include, but not limited to, acrylic compounds such as isooctyl (meth)acrylate, 2-ethylhexylcarbitol (meth)acrylate, n-butyl (meth)acrylate, isostearyl (meth)acrylate and other (meth)acrylic esters, urethane acrylate, epoxy acrylate, polyester acrylate and others. Such a light-curable resin is typically used in combination with a photopolymerization initiator. Particularly preferred ultraviolet-curing resin comprises a mixture of urethane acrylate and dimethylol tricyclodecane diacrylate, or a mixture of urethane acrylate and 1,6-hexanediol diacrylate, with a photopolymerization initiator added thereto. Note that, if necessary, a variety of additives generally used in this technical field may be incorporated into the resins described above. Examples of suitable additives include, for example, a thickening agent, a plasticizer, a dispersing agent, a polymerization inhibitor and the like.

The protective film-forming resins described above are generally coated and cured on a surface of the information recording layer formed over the substrate. Alternatively, the protective film-forming resins may be coated and cured on a surface of the surface treatment medium, in addition to the surface of the information recording layer. If this double surface coating method is used in the production of the optical recording medium, for examples, it becomes possible to easily control a thickness of the resulting protective film. Further, in the practice of this double surface coating method, the same resin may be coated on both of the surface of the information recording layer and the surface of the surface treatment medium, or the resins having different compositions, properties and others may be coated on the surface of the information recording layer and that of the surface treatment medium. For example, if the resins having different adhesion strengths to the adherent, an operation of separating the recording medium from the surface treatment medium can be improved.

While the protective film-forming resin may be applied by other coating methods or film formation methods as required, it is advantageous to apply the resin onto the information recording layer and others by the spin coating process. The spin coating process may be carried out by using a spin coater which is commercially available and under the conventional coating conditions.

The protective film-forming resin has viscosity typically 1,000 centipoises (cps) or higher, preferably in a range from 2,000 to 100,000 cps, more preferably in a range from 5,000 to 100,000 cps. These values of viscosity are preferred because the optical recording medium of the present invention is made by coating the substrate surface and, if necessary, a surface treatment medium with a selected resin to a uniform thickness' by the spin coating process or the like, and then laminating the surface treatment medium therewith with care so as not to allow the thickness of the resin layer to change. For this reason, viscosity of the resin is desired to be high. However, viscosity of the resin must be kept within such a level which allows practical application operation. In addition, a resin having a viscosity which is too low may flow and drip from the periphery of the substrate before being cured after application. In practice, the viscosity less than 1,000 cps causes a variation in the thickness of the resulting protective film, while the viscosity above 100,000 cps suffers from difficulty of coating. Note that the viscosity of the protective film-forming resin, referred to in the specification, was determined at 25° C. using a Brookfield viscometer (BM#2 spindle, 12 revolutions per minute (rpm)) according to Japanese Industrial Standard JIS K 7117-1-1999.

After applying a predetermined amount of the protective film-forming resin onto the information recording layer, the surface treatment medium is laminated onto the substrate so as to sandwich the uncured resin layers at a desired and uniform thickness corresponding to that of the protective film, followed by curing of the resin. Note that, in the double surface coating method in which an additional protective film-forming resin is applied onto the surface treatment medium, as required, the amount of the resin required for the formation of the protective film is a total of this additional resin and the resin applied to the information recording layer. In the case where the resin is an ultraviolet-curing resin, a thin glass sheet (disk) having good transparency to ultraviolet rays and a smooth surface is used as the surface treatment medium. The resin is cured by irradiating the resin with ultraviolet rays emitted by a high pressure mercury lamp through the glass sheet. Alternatively, a plastic sheet or other materials may be used as the surface treatment medium.

The double surface coating method can be advantageously carried out with different embodiments. For example, as described above, with regard to the protective film-forming resin, the same or different resins may be used on the information recording layer and on the surface treatment medium. Further, curing of the coated resin may be carried out after lamination of the substrate and the surface treatment medium or, alternatively, either one of the resin on the information recording layer and the resin on the surface treatment medium may be first cured, and the remaining resin is then cured after lamination of the substrate and the surface treatment medium. Furthermore, in the coating step of the resins, a diameter of the surface treatment medium may be controlled to have a larger size than the surface of the substrate for supporting the information recording medium. In this method, the resin is coated on an overall surface of the surface treatment medium, the area, corresponding to the information recording layer, of the coated resin is selectively cured and the uncured resin is removed from the surface treating medium, followed by laminating the surface treatment medium to the substrate. Using this method, a thickness distribution of the protective film can be easily controlled, along with prevention of shifting in the laminated product and increase of working efficiency.

In the protective film of the optical recording medium, the protective film has a thickness typically in a range from about 50 to 200 μm, preferably from about 60 to 150 μm. The protective film has thickness that is substantially uniform over the entire surface thereof. That is, when the protective film is 100 μm thick, tolerance of the thickness is typically in a range of 100±3 μm.

The protective layer also has preferably excellent surface flatness and smoothness. This is achieved by sandwiching the protective film-forming resin between the substrate and the surface treatment medium which causes the smoothness of the surface treatment medium making contact with the resin layer to be transferred onto the surface of the protective film. Smoothness of the protective film is, in terms of an average surface roughness Ra, typically in a range from 0.02 to 0.08 μm.

The smooth surface of the surface treatment medium may display a wide range of surface energies such that, upon removal of the same, the highest surface energy of the surface treatment medium surface in contact with the cured protective film-forming resin does not disrupt the cured resin surface so as to disallow for the optical recording media's intended use. Similarly the lowest surface energy of the surface treatment medium surface in contact with the uncured resin does not disallow wetting out of the intended surfaces or impede resin flow on or between the same.

The optical recording medium of the present invention comprises the substrate, the information recording layer and the protective film. In addition, it may also have other additional layers such as a printed layer, a non-reflection coat layer, a hard coat layer, an antistatic layer and others.

The optical recording medium of the present invention can be produced advantageously by forming the protective film in the following procedure after conventionally forming the information recording layer on the substrate.

(1) Application of the Protective Film-Forming Resin

The protective film-forming resin having a light transmitting property is applied to the surface of the information recording layer formed on the substrate. Preferably, the selected resin is caused to drip through a nozzle while rotating the substrate using a spin coater or the like, thereby forming a thin film of the selected resin on the substrate. The quantity of the resin to be applied is preferably such that is sufficient to form the protective film with a desired thickness of 50 to 200 μm.

Alternatively, the protective film-forming resin may be applied to a surface (surface at a side of the information recording layer) of the surface treatment medium in addition to the surface of the information recording layer. The protective film-forming resin applied to the surface of the surface treatment medium may be the same as or different from the resin applied to the surface of the information recording layer. The sum of the amount of the resin applied onto the both surfaces is equal to the amount required to obtain the desired thickness in the protective film.

(2). Pressure Contact of the Surface Treatment Medium

In a pretreatment process to obtain the protective film having the desired properties, the surface treatment medium is pressed against the surface of the protective film-forming resin layer. The surface treatment medium used herein has the function of transferring its surface smoothness and therefore may also be called a mold. While detailed characteristics of the surface treatment medium are not limited, the mold surface is required to have a level of smoothness which corresponds to the required smoothness of the protective film. In case a light-curing resin is used, the mold must transmit light, for example ultraviolet rays, to cure the resin. A proper material for the surface treatment medium having light transmitting property includes a glass disk and a plastic sheet. The surface of the surface treatment medium may be subjected to release treatment such as the application of a silicone resin in order to facilitate the release of a surface treatment medium from a substrate after curing the protective film. Also, as described above, the surface of the surface treatment medium may have a previously formed layer of the protective film-forming resin.

After pressing the surface treatment medium against the substrate, the substrate and the surface treatment medium are held parallel to each other, using a proper fixture as required. The distance between the substrate and the surface treatment medium, namely the thickness of the thin film of the resin which is sandwiched there between, is substantially the same as the desired thickness of the protective film assuming that the shrinkage of the resin film by curing is negligible. The thin film does not include fine bubbles or other foreign matter. The substrate and the surface treatment medium may be rotated after being placed one upon another in order to remove excess resin.

(3) Formation of the Protective Film

The protective film-forming resin is cured while being sandwiched between the substrate and the surface treatment medium. The method and conditions of curing can be selected from wide ranges in accordance to the type of resin and other factors. In the case where an ultraviolet-curing resin is used, for example, the resin can be cured by irradiating with ultraviolet rays via the surface treatment medium (glass disk) thereby to form the protective film. Thus, the surface smoothness of the surface treatment medium is transferred onto the surface of the protective film.

Alternatively, when the protective film-forming resin is also coated onto a surface of the surface treatment medium along with a surface of the information recording layer, either one of the two resin layers may be previously cured before the substrate and the surface treatment medium are stacked as described above. In such a case, in the curing step described in the above paragraph, another uncured resin layer is cured. The curing methods and conditions may be optionally changed.

(4) Removal of the Surface Treatment Medium

After the formation of the protective film has been completed, the surface treatment medium used to render smoothness is removed, leaving the protective film having a smooth surface being obtained. The surface treatment medium which has been removed can be reused after being cleaned, thus allowing economical producing operation.

### EXAMPLES

The present invention will be described by way of Examples. The present invention is not limited to these Examples as a matter of course. In the following Examples, “parts” are “parts by weight” unless otherwise indicated.

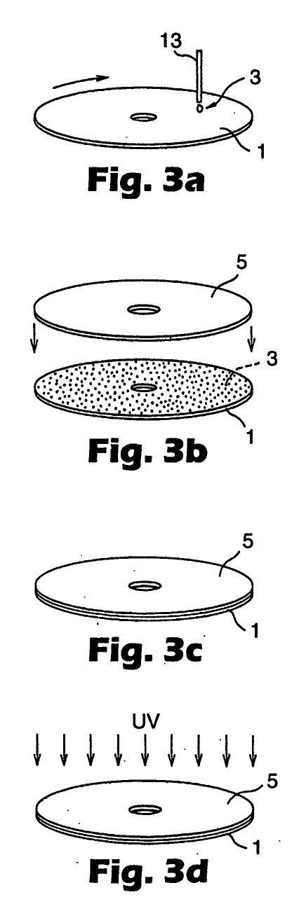

### Example 1 (See FIG. 3)

An optical disk substrate was produced by applying an information recording layer, in a thickness of 50 nm, by sputtering of aluminum onto a transparent circular substrate made of polycarbonate. Then, as shown in the step (A) of FIG. 3, a UV curing syrup 3 was dripped through a nozzle 13 on the nearly center portion of the surface of the disk substrate 1 (information recording layer is not shown) while rotating the disk substrate 1. The syrup 3 used herein was prepared by mixing 30 parts of urethane acrylate (manufactured by Nippon Synthetic Chemical Industry Co., Ltd. under the trade name of “UV6100B”), 70 parts of dimethylol tricyclodecane diacrylate and 5 parts of a photopolymerization initiator (manufactured by CIBA-GEIGY Ltd. under the trade name of Darocure 1173™). A thin film of the UV curing syrup 3 was formed on the surface of the disk substrate 1.

Then, as shown in the step (B), a circular glass sheet 5 (1 mm in thickness) having the same shape and size as those of the disk substrate 1 was laminated on the surface at a side of the syrup 3 of the disk substrate 1. The surface of the glass sheet 5 was previously subjected to a smoothing treatment to impart the same level of the smoothness as that of the required smoothness of the protective film.

As shown in the step (C), the state where the disk substrate 1 and the glass sheet 5 are placed on upon another were retained until the UV curing syrup 3 naturally spreads over the entire disk substrate.

Thereafter, as shown in the step (D), the UV curing syrup 3 was irradiated with ultraviolet rays (wavelength of 200 to 400 nm) via the glass sheet 5 for ten seconds, thereby to completely cure the syrup. The glass sheet 5 was removed from the disk substrate 1 by the hand to obtain an optical disk having an about 100 μm-thick protective film on the surface.

Test Methods

Thickness of Protective Film:

The thickness of a protective film of the optical disk sample was measured based on the specified measuring conditions in a non-destructive and non-contact manner, using a thickness measuring device equipped with a multi-focal optical sensor manufactured by KEYENCE Corporation, Osaka, Japan. As a result, the measurement results as shown in Table 1 were obtained. In Table 1, “average thickness (μm)” means an average thickness of thicknesses of protective films of two samples, while “variation in film thickness (difference between maximum value and minimum value, μm)” means an average value with respect to the whole optical disk and a measured value with respect to each of six kinds of tracks (Tr. 1 to Tr. 6) having different circumferences and radiuses.

Surface Smoothness of Protective Film:

The surface smoothness of the protective film of the optical disk sample was measured with regard to the surface roughness. The surface roughness of the protective film was measured using a laser confocal microscope, available from KEYENCE Corporation, Osaka, Japan, as Model Number VF-750. The instrument incorporates software which calculated the average surface roughness as “Ra” of the surface according to JIS B 0601-1994. The average surface roughness Ra recorded in micrometers (μm) is defined as the surface smoothness of several individual measurement areas determined according to JIS B 0601-1994. The measurement results as shown in Table 1 were obtained.

Absorption at the Wavelength (λ=400 Nm) of the Recording and Reading Laser:

To measure whether or not absorption is recognized at the wavelength (λ=400 nm) of the recording and reading laser in the protective film of the optical disk sample, in place of using a real protective film, a 100 μm-thick film of the above-described UV curing resin was used to determine a transmittance of the light having a wavelength of 400 nm on spectrophotometer, Type 3500 (trade name from Hitachi). As a result, the measurement results as shown in Table 1 were obtained.

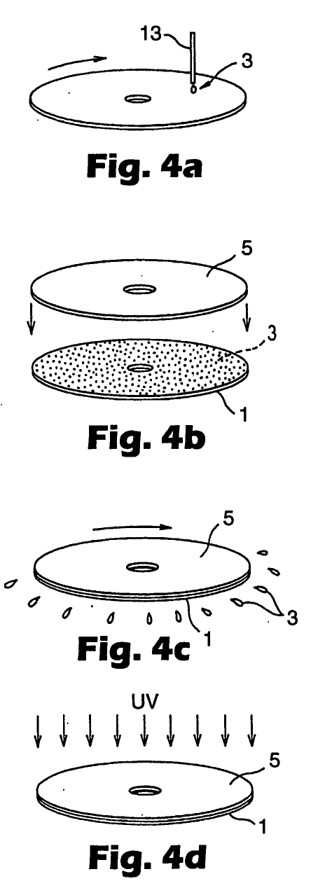

### Example 2 (See FIG. 4)

An optical disk substrate was produced by applying an information recording layer in a thickness of 50 nm by sputtering aluminum onto a transparent circular substrate made of polycarbonate. Then, as shown in the step (A) of FIG. 4, a UV curing syrup 3 was dripped through a nozzle 13 on the nearly center portion of the surface of the disk substrate 1 (information recording layer is not shown) in the form of as a doughnut while rotating the disk substrate 1. The syrup 3 used herein was prepared by mixing 60 parts of urethane acrylate (manufactured by Nippon Synthetic Chemical Industry Co., Ltd. under the trade name of “UV6100B”), 40 parts of 1,6-hexanediol diacrylate and 5 parts of a photopolymerization initiator (manufactured by CIBA-GEIGY Ltd. under the trade name of Darocure 1173™). A doughnut-like thin film of the UV curing syrup 3 was formed on the surface of the disk substrate 1.

Then, as shown in the step (B), a circular glass sheet (1 mm in thickness) having the same shape and size as those of the disk substrate 1 was laminated on the surface of the syrup 3 of the disk substrate 1. The surface of the glass sheet 5 was previously subjected to a smoothing treatment to impart the same level of the smoothness as that of the required smoothness of the protective film.

As shown in the step (C), the disk substrate 1 and the glass sheet 5 were placed on upon another, and then excess UV curing syrup 3 was removed while rotating at high speed in the direction shown by the arrow. As a result, a thin film having a predetermined thickness made of the UV curing syrup 3 was formed.

Thereafter, as shown in the step (D), the UV curing syrup 3 was irradiated with ultraviolet rays (wavelength of 200 to 400 nm) through the glass sheet 5 for ten seconds, to completely cure the syrup. The glass sheet 5 was removed from the disk substrate 1 by hand to obtain an optical disk having an about 100 μm-thick protective film on its surface.

In the same procedure as in Example 1, a series of evaluation tests were carried out. As a result, the measurement results as described in Table 1 were obtained.

### Comparative Example 1

The same procedure as in Example 1 was repeated, except that the surface of a disk substrate was spin-coated with a UV curing syrup in a thickness of 100 μm and the syrup was completely cured by irradiating with ultraviolet rays (wavelength of 200 to 400 nm) for ten seconds, for comparison. In this example, a glass sheet was not used as a mold for transferring the smoothness.

In the same procedure as in Example 1, a series of evaluation tests were carried out. As a result, the measurement results as described in Table 1 were obtained.

### Comparative Example 2

The same procedure as in Example 1 was repeated, except that a protective film was formed by bonding a polycarbonate sheet (thickness of about 70 μm) onto the surface of the disk substrate through by means of a pressure-sensitive adhesive layer (thickness of about 30 μm) in place of forming a protective film derived from the UV curing syrup on the disk substrate, for comparison.

In the same procedure as in Example 1, a series of evaluation tests were carried out. As a result, the measurement results as described in Table 1 were obtained.

TABLE 1

| | | | | Transmittance of |
|---|---|---|---|---|
| | Average | | Surface | light at the |
| | thickness | Variation in film | roughness | wavelength |
| | (μm) | thickness (μm) | Ra (μm) | of 400 nm (%) |
| Example 1 | 102 | 5.8 | 0.02 | 91 |
| Example 2 | 98 | 3.7 | 0.02 | 91 |
| Comp. | 97 | 23.6 | 0.02 | 91 |
| Example 1 | | | | |
| Comp. | 98 | 2.2 | 0.06 | 90 |
| Example 2 | | | | |

As is appreciated from the measurement results described in Table 1, according to the present invention, it becomes possible to obtain an optical disk provided with a protective film having better various characteristics than those of the prior art optical disks.

As described above, according to the present invention, there can be provided an optical recording medium of a high quality, which has a protective film that is thin with little variation in the film thickness and has a smooth surface, thereby to satisfy the requirements for larger capacity and higher density recording medium. Also according to the present invention, such an optical recording medium of a high quality can be produced, easily and at a low cost. Furthermore, according to the present invention, it is made possible to prevent such troubles as dust depositing on the protective film, scratches, bending, and defects in radial direction during the production of the optical recording medium.

What is claimed:

1. An optical recording medium comprising a substrate, an information recording layer formed on the substrate, and
a protective film comprising a light transmitting resin provided on the surface of the information recording layer;
wherein the protective film has a substantially uniform thickness in a range from 50 to 200 μm, and has a surface which reproduces the smoothness of the surface of a surface treatment medium which has been covering the surface of the protective film during the formation thereof.

2. The optical recording medium of claim 1, wherein the protective film is formed by applying a protective film-forming resin to the surface of the information recording layer and then curing the resin after covering with the surface treatment medium.

3. The optical recording medium of claim 2, wherein the protective film-forming resin is a photocurable resin.

4. The optical recording medium of claim 1, wherein the surface of the protective film has an average surface roughness, Ra, of from about 0.02 to about 0.08 micrometers.

5. The optical recording medium of claim 2 wherein the surface treatment medium is a glass sheet or a plastic sheet.

6. A method of producing an optical recording medium comprising a substrate and an information recording layer and protective film which are formed in order on the substrate, which comprises the steps of:
(i) applying a light transmitting protective film-forming resin to the surface of the information recording layer, in an amount sufficient to form the protective film, the protective films having a thickness in a range from 50 to 200 μm;
(ii) covering the surface of the protective film-forming resin with a surface treatment medium which has a surface of smoothness corresponding to the smoothness of the protective film;
(iii) curing the protective film-forming resin to laminate this substrate and the surface treatment medium, thereby transferring the smoothness of the surface of the surface treatment medium onto the protective film; and
(iv) optionally removing the surface treatment medium.

7. The method of claim 6, wherein a protective film-forming resin which may be the same or different from the protective film-forming resin is further applied to the smooth surface of the surface treatment medium so that the total thickness of the resulting two layers of the protective film-forming resin on the information layer and on the surface treatment medium becomes equivalent to the thickness of the protective film.

8. The method of claim 7, wherein either one of the two layers of the protective film-forming resin is previously cured before the lamination of the substrate and the surface treatment medium.

9. The method of claim 6, wherein a photocurable resin is used as the protective film-forming resin so that the photocurable resin is cured by light which has been transmitted through the surface treatment medium to form the protective film.

10. The method of claim 6, wherein the protective film-forming resin is applied by spin coating process to the surface of the information recording layer and, if necessary, the surface of the surface treatment medium.

11. A protective film for an optical recording medium comprising a photocurable film-forming resin which is cured by light which has been transmitted through an adjacent medium thereby to form the protective film.

12. The protective film of claim 11, wherein the protective film-forming resin has a viscosity of 1,000 to 100,000 cps at 25° C.
